(19) United States
(12) Patent Application Publication
(10) Pub. No.: US 2002/0083018 A1
(43) Pub. Date: Jun. 27, 2002

(54) Method and system for batch mail processing utilizing a web browser in a postal or shipping system

(75) Inventors: Terri A. Carroll, Trumbull, CT (US); David A. Ellis, Wallingford, CT (US); Jacques E. Hasbani, Easton, CT (US)

Correspondence Address: Pitney Bowes, Inc., Intellectual Property and Technology Law Dept., 35 Waterview Park Drive, P.O. Box 3000, Shelton, CT, 06484, US

(73) Assignee: Pitney Bowes Incorporated, Stamford, CT (US)

(21) Appl. No.: 09/749,352

(22) Filed: Dec. 27, 2000

(51) Int. Cl. G06F 17/00; G07B 17/02

(52) U.S. Cl. 705/401

(57) ABSTRACT

The invention is a method and system for batch mail processing using a web browser-based postal mail shipping system. The data processing system comprises a web site for a provider server and a client node in communication with the provider server. The web site further comprises web pages and script functionality for linking with a meter driver resident in a meter located at the client node, but callable by the client node under the control of the script functionality for allowing the script at the client node to link with the meter by utilizing the meter driver. The method is initiated by calling a web site from the caller node by utilizing communications link, which includes a browser for accessing the web site. The client node requests that a meter activation routine be activated. A user enters a postage value for a mail piece in a batch. Batch processing then begins, and the running batch count and value are displayed to the user on the web page. After the batch is processed, the final batch counts are displayed to the user on the web page.

### FIELD OF INVENTION

The present invention relates generally to the field of mail piece and/or parcel processing in a network and, more specifically, to the field of batch meter processing integrated within an Internet or intranet data processing environment. Specifically, this invention relates to batch mail processing utilizing a web browser.

### BACKGROUND OF THE INVENTION

Business planning and organization often depend upon the ability of systems to accurately process up-to-date information. This processing includes the management of information which enables the daily operations of the business and includes such functions as managing operational funds, which further includes those funds used for postal processing. Businesses, large and small, require the same understanding as to where and how funds are used within the business. Small or large business mailroom operations, busy mail centers both have the potential for unauthorized transfer of postal funds. This expense can be significant; therefore, it has become important for firms to detect whether the funds contained within the firm's postage meter or similar system are accurate. This includes enabling detection as to whether or not postal funds have been added or deleted, either on, or off, line.

Postal processing can be described as falling within two distinctive areas: shipping/carrier and mailing systems. Both systems require the application of funds to enable postal or item processing.

Systems that allow the user to process parcels for delivery by a carrier are known as “shipping systems”; or, if the intent of the system is to allow the user to choose from among the services of more than one carrier, the system may be known as a “carrier management system”. Carrier management systems are referred to as “shipping systems” and are designed to prepare parcels in accordance with the regulations of the carrier that will be transporting the parcels for later delivery. Systems that allow the processing and delivery of individual mail pieces within the control of the postal authorities are generally referred to as “mailing systems”. Mailing systems may simply include a postage meter for printing postage payment evidencing on an envelope; or, they may be sophisticated systems for complete mail piece processing. These systems may include a scale for weighing the mail piece and for determination of the postage amount. In addition, these systems may integrate the ability to print and personalize a document, match an envelope to the document, include preprinted sheets with the mail piece and/or to accumulate, fold and insert the completed mail piece into an envelope to be sealed.

Traditional configurations of shipping include low-end, embedded systems, mid-range personal computer (PC) based systems, and upper and mid-mainframe based systems.

Embedded systems, in which the shipping application is embedded within a shipping scale, generally include PROM-based rating tables and their associated functionality. Data entries to the application are made via an operator keypad on the front of the scale or by scanning bar codes or similar symbology directly to certain fields within the application. Table data and certain rating functionality are generally added through the use of PROM's. These systems might also interface with a postage meter for producing proof of payment for a carrier, such as the United States Postal Service (USPS).

PC-based systems are more flexible than embedded systems because they allow a greater range of peripheral interface, greater memory capability, networking capabilities via the Internet or an intranet, and the ability to store records and address lists while accepting data download in a variety of ways. Rating and services functionality are also directed from the application, while the system shops for an appropriate rate from a database residing in a memory contained within the PC or from a rating table directed by a server. Address lists can be stored or forwarded as well. The ability of the PC-based system to provide a communications link to a network while allowing integration with a client's information systems is, perhaps, the greatest strength of these systems. Network links via the Internet provide the system with an interface to a greater number and variety of carriers' web sites, increased functionality, and parcel tracking. Additionally, data relevant to shipping history for a particular location or historical manifest data can be downloaded or uploaded in a quick and efficient manner, as necessary.

The PC-based systems offer much the same functionality as the upper end and mid-mainframe systems. The upper systems, however, offer the advantage of exceptional processing speed while handling large volumes of transaction data or performance through multitasking of application services, as well as application level integration with client systems.

Traditional mailing systems include dedicated systems used for metering, or integrated systems including PC processing in which a document may be created and metered for delivery. These systems have been designed to service the small and large office, based in part on volume and processing requirements. For example, some mailing systems may include only a meter for marking a mail piece with a designated amount of postage, while other systems couple the meter to a scale which enables automatic application of postal rate parameters. Still, other mailing systems include a PC for enabling document creation, printing and enveloping before applying metered evidence of postage payment.

Shipping and mailing systems both have benefited from the efficiencies associated with PC-based programs, peripherals, and applications. Labels can be printed at the desktop; weighing scales are interconnected to PC's for inputting weight to parcel shipping applications; and, manifests for recording the details of parcel pickup and delivery are printed at the desktop as well. Furthermore, document creation, address cleansing and, in general, mail processing have also been advanced with the use of a PC. Address peripherals, such as postage meters for payment evidencing, and other input devices, can also be added for increased data delivery.

In an enterprise environment which employs PC-based shipping or mailing systems, either a stand alone system, or one that is part of a local area network (LAN), or even a wide area network (WAN), the ability to manage meter asset functionality has become important. Specifically, firms have become highly concerned with detecting postage meter fund discrepancies and the potential unauthorized use or misappropriation of meter funds. One such system that has addressed this issue, the ASCENT® carrier management system, is commercially available from Pitney Bowes Inc., of Stamford, Conn. The ASCENT® system is a dedicated system that offers multi-carrier automated processing designed to maximize the productivity of mail or shipping room centers.

ASCENT® manages mail, small parcel, air express, international, and regional or courier services in one system. The system includes delivery confirmation support, cost-saving electronic data transmission, integrated tracking, and barcode label printing. Also provided is differential weighing, which provides efficient processing of mixed weight envelopes and flats. As well, the system automates processing of certified mail and return receipt forms.

Currently, however, there exists no effective way to provide batch mail meter processing while using an Internet browser for Internet-based applications being directed from a server. A browser-based system would eliminate the requirement for dedicated systems, thus enabling a broader range of customer access to both the shipping/carrier and mailing systems. Furthermore, a browser based system would provide an easily scalable solution to both small businesses and large enterprise environments. Browser based systems are also less expensive because very little customer software is required at the client. Therefore, a method and system are required that allow a system user to enable batch mail meter processing directly from an Internet or intranet-based application, while utilizing a browser.

### SUMMARY OF THE INVENTION

According to the present invention, a method and system for batch mail processing using a web browser-based postal mail and shipping system is provided. The system comprises a web site for a provider server and a client node in communication with the provider server. The web site further comprises provider web pages and script functionality resident in the provider web pages for linking with a meter driver resident in a client computer that is in communication with a postal meter attached at the client node. The client node can be one of a plurality of client nodes that are linked to the system, at least one client must be operatively connected to a postal meter.

The meter at the client node further comprises: a meter driver; a meter server resident first at the client computer but callable under control of the script functionality; and, script activation capability for allowing the script at the web site to link with the postal meter by utilizing the meter driver.

The method is initiated by calling a web site associated with the provider server from the client node by utilizing a communications link for linking the web sites and the postal meter at the client node. The communications link comprises: a browser for accessing the web site by the client node; a network interface routine for allowing access to a network wherein the web site resides; and communications means for physically interfacing the postal meter with the client node and ultimately with the network itself.

The client node requests that a postal meter activation routine be activated at the web site for download to the client. The routine includes the use of script (such as JAVASCRIPT™ available commercially from Sun Microsystems, Inc. of Pal Alto, Calif.) to call an ACTIVE X™ automation server. ACTIVE X™ is a set of integration technologies that enables software components to inter-operate in a networked environment using any programming language. The user selects the option to perform a meter batch and enters information to identify batch such as account number, postage value, description, job number of identification or some other means. At this point, the user also enters for each mail piece the script language and then calls the meter server to begin the meter batch operation and set the postage value to the previously entered number. The script, through the meter server, requests the batch value and batch count and displays them on the web page. A mail piece is processed, and an indicia is then printed. The system continues the process until completion of the batch processing or until the operation is cancelled by the user. After the batch is processed, the final batch counts are displayed on the web page to the user.

### BRIEF DESCRIPTION OF THE DRAWINGS

FIG. 1 is a block diagram of the overall system of the present invention.

FIG. 2A is a flowchart of the method of the present invention.

FIG. 2B is a continuation of the flowchart of FIG. 2A.

FIG. 2C is a continuation of the flow chart of FIG. 2B showing the method flow of batch mail processing of the system of the present invention.

FIG. 2D is a continuation of the flowchart of FIG. 2C showing the method flow of the end batch processing of the system of the present invention

### DETAILED DESCRIPTION OF THE PREFERRED EMBODIMENTS

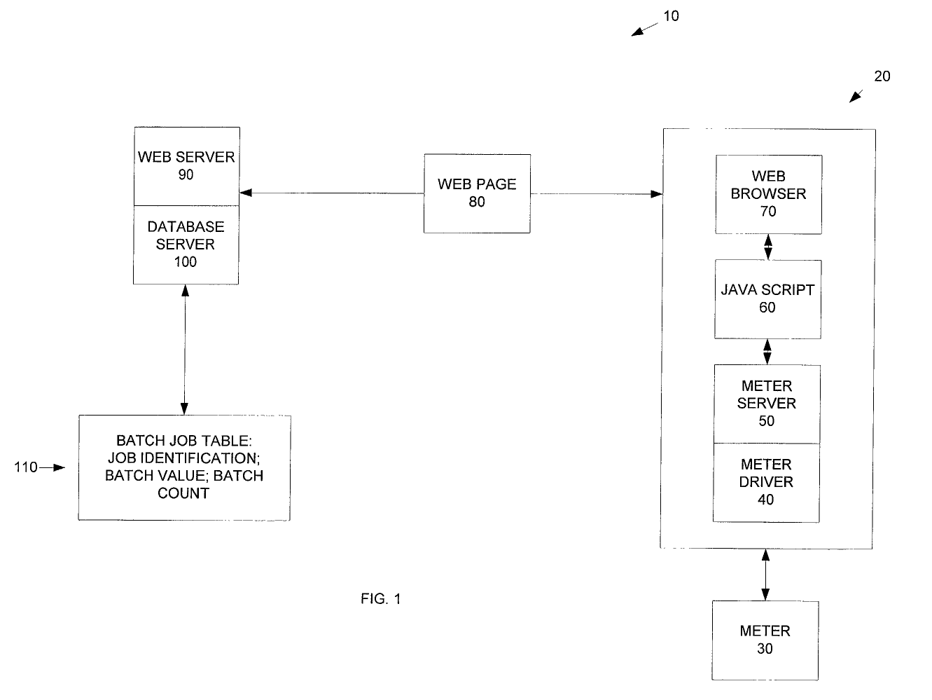

Now turning to FIG. 1, there is shown a block diagram of system 10 of the present invention showing the system flow between each of the high-level components situated in either an internet or an intranet environment. System 10 includes client computer 20, which may be a PC or a thin client network computer such as a PALM PILOT™ commercially available from 3Com Corporation of Santa Clara, Calif. Client computer 20 is operatively connected to postage meter 30 through a communications cable such as an RS232 protocol cable. Client computer 20 further includes web browser 70 (also known as a web client).

A web browser is software that makes it easy to access information on the internet. Browser software interprets the Hyper Text Markup Language (HTML) codes in web pages so that the pages can be viewed in a readable format. The browser software enables a specific connection to a network address called a Uniform Resource Locator (URL), which sends a request to a web server, such as web server 90 for a particular addressed document, i.e., web page 80. Web server 90 responds by sending to web page 80 text and/or other media such as video and/or audio for use by PC 20. Web page 80 is sent in the HTML format. A scripting language such as JAVASCRIPT™, enables communication between the application and meter server 50. In other words, meter server 50 is an application program, which provides an interface to the script 60 such that the script call can then perform certain functions.

JAVASCRIPT™ is a compact, object-based scripting language for developing client and server Internet applications. JAVASCRIPT™ is included in web pages and runs with the aid of a web browser. In addition, JAVASCRIPT™ can implement programmer-defined functions, which can create very interactive client side pages.

Meter server 50 and meter driver 40 enable communication using JAVASCRIPT™ between meter 30 and Browser 70. Communication may be accomplished using object-oriented programming. Object oriented design (OOD) programming languages are useful in removing some of the restrictions that have hampered application design due to the inflexibility of traditional programming languages.

OOD utilizes a basic element or construct known as the “object,” which combines both a data structure and an intended behavior characteristic within the single element. Objects are bundles of data and the procedures which best identify the use of that data. Objects can be specific or conceptual and are often used to represent models of real-world object groupings; this has the effect of helping software applications become an organized collection of discrete objects in which data is held or moved based on the intended behavior of an object which is inherently unique. Each object knows how to perform some activity.

The objects interact and communicate with each other via messages. A message is initiated by one object for the purpose of getting a second message to perform an act such as performing the steps of a method. Information parameters may be passed along with the message so that the receiving object will have guidelines for performing its action. OOD is known in the art of computer programming; therefore, a detailed description is not necessary for an understanding of this invention.

Further to FIG. 1, web server 90 communicates with database server 100 using a server side scripting language and/or data base objects, which in turn communicate with at least one batch job table 110. Batch job table 110 includes data about meter 30 such as, for example: job identification, batch value and batch count.

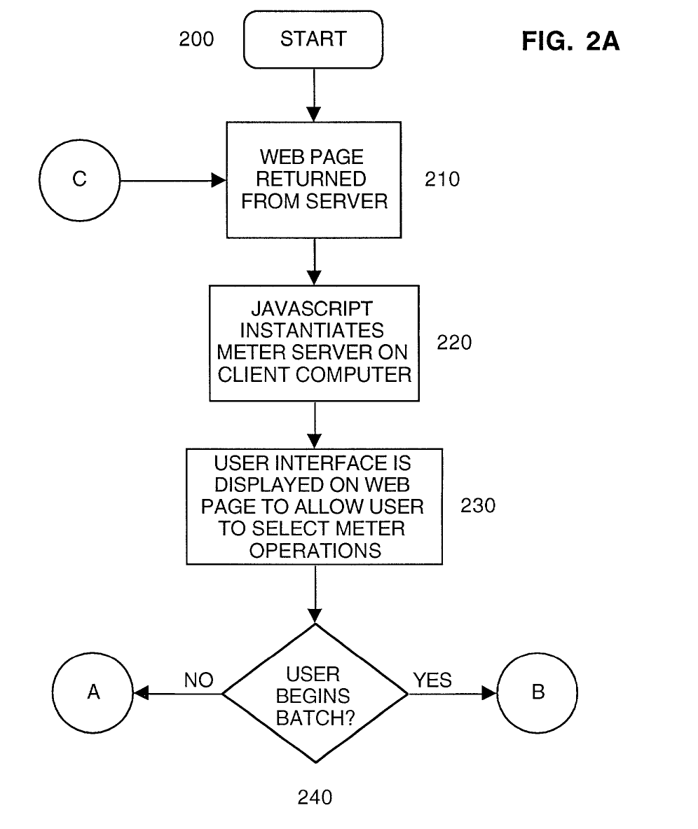

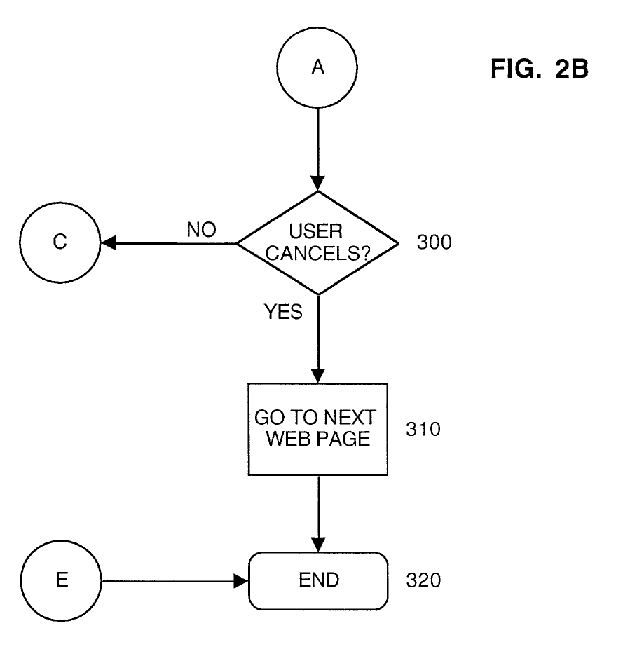

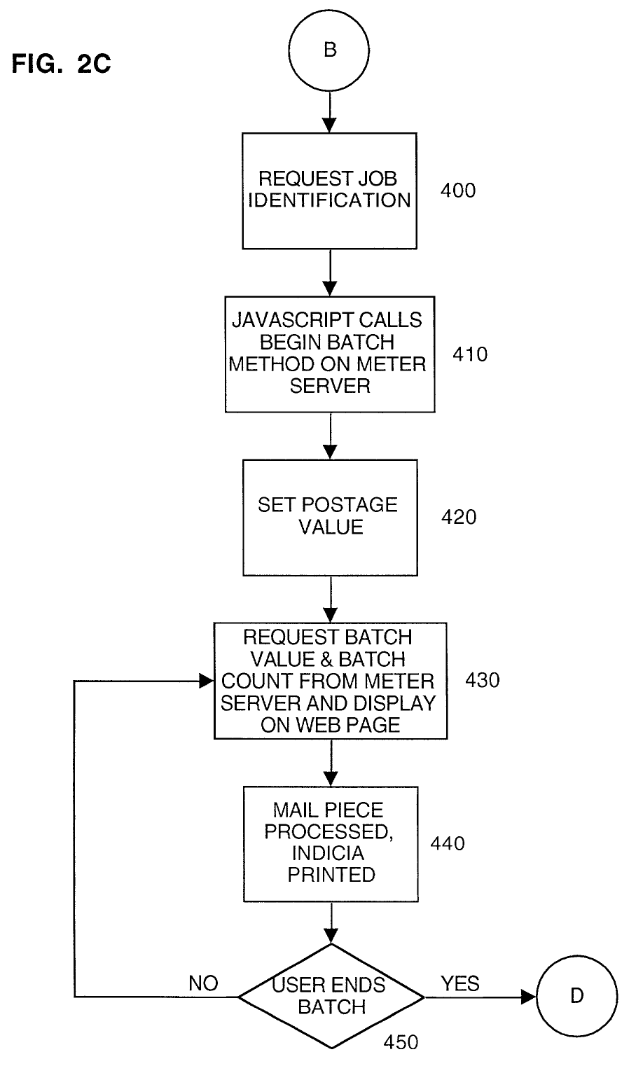

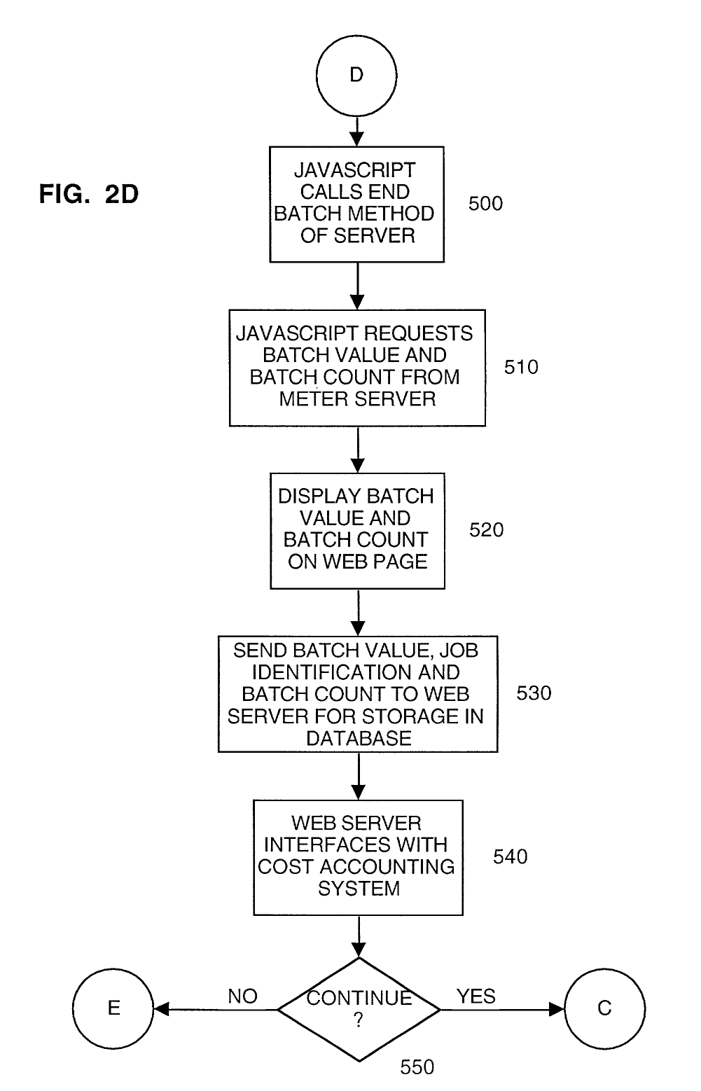

Now turning to FIG. 2A, there is shown a flowchart of the operation of the batch mail processing of the present invention. The method begins at step 200 where the user initiates the system. The user requests the appropriate web page 80 by inputting the associated URL by advancing to step 210. At step 210, web page 80 is returned to PC 20 from web server 90. Additionally, path C re-enters at step 210 from steps 300 and 550. From step 210 the method advances to step 220.

At step 220, script call 60 instanstiates meter server 50 on client computer 20 before proceeding to step 230. At step 230, the method queries as to whether or not the user will begin batch processing by pressing a button or some other indicator means, such as voice recognition, touch recognition, or light response. If the answer to the query is “YES”, then the method progresses along path B to step 400. If, however, the answer to the query at step 240 is “NO”, then the method as is shown in FIG. 2C continues along path A to step 300 as is shown in FIG. 2B.

Now turning to FIG. 2B, the method flow re-enters along path A at step 300 where the user is queried as to whether or not to cancel the method by either pressing a button, speaking, touching or otherwise indicating such method cancellation. If at step 300 the answer to the query is “NO”, then the method proceeds along path C to re-enter at step 210 as is shown in FIG. 2A. If, however, the answer to the query at step 300 is “YES”, then the method proceeds to step 310. At step 310, the method instructs the system to go to the next web page. The method then ends at step 320. Path E coming from step 550 of FIG. 2D is shown terminating at step 320 as well.

Now turning to FIG. 2C, the method flow described at FIG. 2B re-enters the flow at FIG. 2C along path B and continues to step 400. At step 400, the method requests a job form identification, such as an identification number. The method then continues to step 410 where script calls “Begin Batch” method on meter server 50. From step 410, the method advances to step 420 where the postage value is set by the user. Progressing to step 430, the method requests the Batch Value and Batch Count from the meter server 50 and displays the information on the web page 80 before advancing to step 440. At step 440, the mail piece is processed, and the indicia is printed. The method then advances to step 450, where the user is queried as to whether to end the batch. If the answer to the query at step 450 is “NO”, then the method loops to step 430. If, however, the answer to the query at step 450 is “YES”, then the method progresses along path D to re-enter the method flow at step 500 as is shown in FIG. 2D.

Now turning to FIG. 2D, the method flow re-enters along path D and continues to step 500 where script calls End Batch method of the meter server 50. The method continues to step 510 where the script then requests Batch Value and Batch Count from meter server 50. Proceeding to step 520, the Batch Value and Batch Count are displayed on Web page 80 before advancing to step 530. At step 530, the Batch Value, Batch Count, and Job Identification are sent to storage in database server 100. The method then proceeds to step 540, where web server 90 interfaces with associated Cost Accounting Systems. Once the method has made any necessary adjustments to the Cost Accounting files, the method advances to the query at step 550. At step 550, the method queries as to whether or not the system user wishes to continue processing. If the response to the query is “YES”, then the method advances along path c to re-enter the method flow at step 210 as is shown in FIG. 2A. Otherwise, if the response to the query at step 550 is “NO”, then the method advances along path E to end the sequence at step 320 as is shown in FIG. 2B. The method then proceeds along path C.

The above specification describes a new and improved system and method for automatically transferring information in a data processing system. It is realized that the above description may indicate to those skilled in the art additional ways in which the principles of this invention may be used without departing from the spirit of the invention. Therefore, it is intended that this invention be limited only by the scope of the appended claims.

What is claimed is:

1. A method for mail batch processing using a web browser-based shipping system comprising the steps of:
(a) operatively connecting a meter to a client;
(b) running a web browser program on said client for communicating with a web server;
(c) running a meter application on said web server;
(d) entering a postage value for each mail piece of said mail batch into said web browser for setting said meter to a specific postal value;
(e) displaying said meter batch value to a system on a web page;
(f) processing said each one of said mail pieces at said meter;
(g) updating said batch value and a piece count based upon said processing information.

2. The method of claim 1, wherein said batch value and said batch count are continually displayed on said web page during said batch processing.

3. The method of claim 1, wherein a final batch value and said batch count are displayed upon completion of said batch processing.

4. A method for postage meter asset management using a web browser-based shipping system comprising the steps of:
(a) operatively connecting a postage meter to a client;
(b) running a web browser program on said client for communicating with a web server;
(c) running a postage meter application on said web server;
(d) running a postage meter automation server on said client;
(e) communicating between said automation server and said web server using a script call;
(f) storing in said meter application a first set of data related to said postage meter;
(g) entering a postage value for each mail piece into said web browser for setting said meter to a specific postal value;
(h) displaying meter batch value to user on said web page;
(i) processing said mail piece at said meter;
(j) updating said batch value and said batch count based upon said processing information.

5. The method of claim 4, wherein said script call is JAVASCRIPT™.

6. A system for mail batch processing using a web browser-based postal mail shipping system comprising:
(a) a postage meter operatively connected to a client for performing a meter batch processing;
(b) a web browser program running on said client for communicating with a web server; and
(c) a postage meter application running on said web server, said postage meter application data processing a meter batch on said meter and continuously updating said batch values and said batch counts on said web browser.

7. The method of claim 6, wherein said batch value and said batch count are continually displayed on said web page during said batch processing.

8. The method of claim 6, wherein a final batch value and batch count are displayed upon completion of said batch processing.
